(19) United States
(12) Patent Application Publication
(10) Pub. No.: US 2003/0045414 A1
(43) Pub. Date: Mar. 6, 2003

(54) Overwrap carton and machine for applying to containers

(76) Inventors: Donald A. Cooper, Teaneck, NJ (US); Christopher R.H. Ganz, Rockaway Twp, NJ (US); Fred Naumann, Old Tappan, NJ (US); Frank L. Conley, Bergenfield, NJ (US)

Correspondence Address: Law Offices of William H. Holt, Unit 2-First Floor, 1423 Powhatan Street, Alexandria, VA, 22314, US

(21) Appl. No.: 10/195,563

(22) Filed: Jul. 16, 2002

Related U.S. Application Data
(60) Provisional application No. 60/305,136, filed on Jul. 16, 2001.

(51) Int. Cl. B26D 5/42; B31B 49/00

(52) U.S. Cl. 493/51; 229/103.2; 229/198.2; 229/900

(57) ABSTRACT

A paperboard blank for forming a carton and a machine for applying the same to a series of containers for forming a package without the need for glue or other adhesives and including novel gussets attached between a locking panel and a front panel, the gussets being properly placed in position by the machine and held in place by the weight of the containers in the finished package, thereby holding the front panel in a closed position. A particular embodiment includes drinking straws, or the like, which are protected by the front panels upon assembly of the completed package.

### BACKGROUND OF THE INVENTION

It is known to use a paperboard carton blank for enclosing a plurality of containers and thereby forming a package for storing, shipping and/or displaying products for sale. Many of such packages require the use of glues or other adhesives for closing the packages and keeping the various panels in proper location.

### SUMMARY OF THE INVENTION

The present invention relates to an overwrap paperboard carton and a machine for applying the same to a plurality of liquid containers such as used for food and other liquid products and, more particularly, to containers for beverages of the type which are traditionally consumed by adults and children using a drinking straw, i.e., fruit juice, fruit drink, milk, cola and the like. The use of glue or other adhesives is not needed in view of the novel arrangement of panels and a gusset for holding panels in proper position in the completed package.

Products of the foregoing type are sometimes provided with a drinking straw detachably connected to the exterior of the container for the convenience of the retail purchaser. A plurality of containers, generally four, six or eight arranged in parallel rows, are grouped together for transportation, display and sale. It is also contemplated that the invention can be used with a single container, or with two or more containers aligned in a single row.

A primary purpose of the present invention is to provide a novel overwrap carton for grouping together a plurality of containers which have individual straws attached thereto; these straws may be used for drinking, or may be used for directing fluids from the container under internal pressure. The carton is designed to enclose the plurality of containers with the added benefit of protecting the straws against damage and against becoming detached from the individual container.

The invention also includes a novel machine for applying the overwrap carton to the containers. The carton contains a novel gusset arrangement at one end thereof in order in combination with front flaps that are folded into position and locked into place without any glue requirement.

This novel structure of the carton requires a novel arrangement of machine parts for properly closing, folding and locking the front container flaps.

### BRIEF DESCRIPTION OF THE DRAWINGS

FIG. 1 shows an assembly line including a series of sequential Stations identified as Station #1, #2, #3, #4, #5, 6 and #7.

FIG. 2 illustrates a Station #5A which shows a more detailed view of Station #5.

### DESCRIPTION OF THE PREFERRED EMBODIMENTS

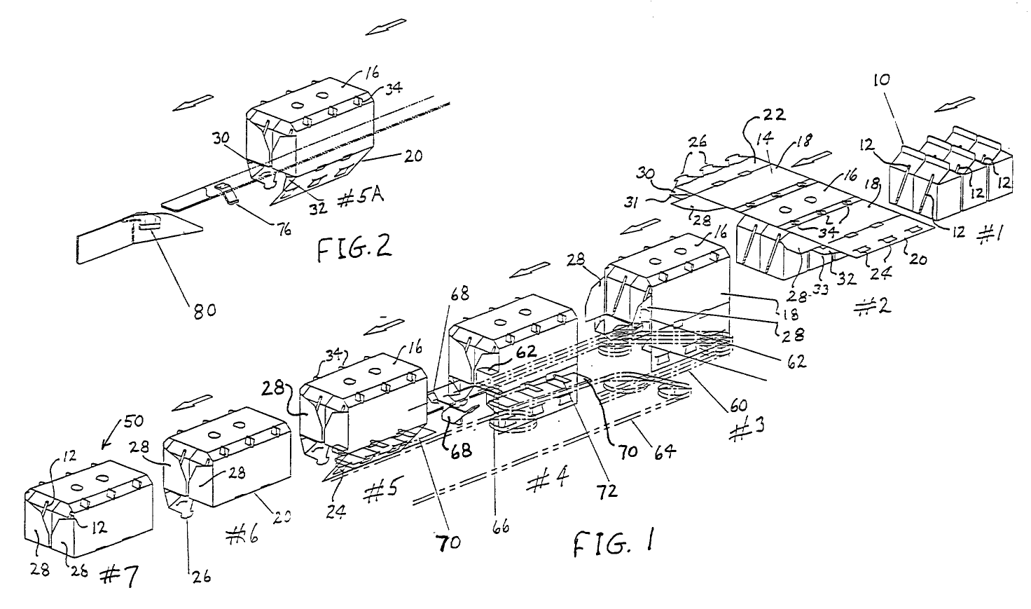

Station #1, as shown in FIG. 1, illustrates a plurality of containers 10 which are grouped by conventional helical in-feed from a two lane slip conveyor (not shown) into two converging flexible positive chains, all in a known manner. It is to be understood that while a group of six containers 10 is shown, other groupings, such as two, three, four or more are within the scope of the invention. It is shown that each container 10 has a dispensing straw 12 temporarily attached to a forward side thereof.

At Station #2 a paperboard carton blank, generally indicated by the numeral 14, includes a plurality of panels and flaps defined by and joined along a plurality of unnumbered fold lines, as is known in the art. The carton blank 14 is taken from a conventional magazine by vacuum cups (not shown), in a known fashion, and placed on top of the grouped containers 10. Carton blank 14 includes a top panel 16 and a pair of side panels 18 extending therefrom. Each side panel 18 includes a locking panel 20 or 22 attached thereto along a fold line. Locking panel 20 includes a plurality of openings 24 for receiving a corresponding number of locking tabs 26 which are attached along a marginal edge of locking panel 22. Each side panel 18 is provided along a fold line with an end or front panel 28, the purpose of which is to protect the straws 12 against damage, as will be later described, and close a front end of the completed package. It is an important part of the novel carton blank 14 that each end or front panel 28 is connected along fold lines to its respective locking panel 20 or 22 by a foldable gusset 30 and 32, each of which contain a central fold line 31 and 33 for a purpose to be later described.

At Station #3 the side panels 18, 18 are plowed down in a conventional manner so that a portion of each gable-topped container 10 is captured in diamond-shaped openings 34 to secure the containers 10 within the carton 14.

At Station #4 each of front panels 28 is folded across the front of the containers 10 and the gussets 30 and 32 are folded along respective fold line 31 and 33 and tucked inwardly to provide a locking arrangement by being folded to a horizontal position beneath the forward-most containers 10 such that the weight of containers 10 hold the gussets 30 and 32 in place with the flaps 28, 28 likewise retained in alignment with each other across the front of the package at a right angle to, i.e., normal to the side panels 18 without the need for any glue or other adhesive.

At Station #5, and as more clearly shown at Station #5A, locking panels 20 and 22 are folded upwardly beneath the nearly completed package and the locking tabs 26 are secured within the openings 24 in panel 20.

A completed package, generally indicated by the numeral 50 is shown at Station #6 and illustrates that front panels 28, 28 are folded across the front of the package to close the front of the package and to secure and protect straws 12 against damage and/or detachment from their container 10, if and when straws 12 are provided in the final package.

Extending along Stations #3, #4, #5 and #5A, a package carrier chain 60 is illustrated on only one side of the carrier line for clarity. As the assembly of containers 10 and carton 14 is moved along the line, front panels 28, 28 are folded inwardly, the folding being initiated by a block 62 projecting inwardly and mounted to the package carrier chain 60. A compression chain 64, being shown only on one side for purposes of clarity, carries a folding block 66 to support the bottom of panels 20 and 22, the latter being held by the block 62 on the carrier chain 60. As is best shown at Station #4, a “y” arrangement of two brackets 68 pre-breaks the locking tab folds by contacting the locking tab fold lines. Conventional compression chain plates 70 are utilized in a known fashion for cooperating with compression lugs 72.

As is best shown in FIG. 2, at Station #5A, a finger 76 plows the gusset 32 just before the bottom panel 20 is completely folded up. In a similar fashion, a plow 80 folds the gusset 30 and locking panel 20 along its fold line before the bottom panel 22 is folded up and before locking tabs 26 are inserted into openings 24 for securing the package 50.

It is to be understood that the disclosed, preferred embodiment is subject to various modifications that would be obvious to those skilled in the art after being exposed to the foregoing description and the accompanying drawings. It is further to be understood that the invention is defined as being within the scope of the following claimed subject matter.

We claim:

1. A carton blank including a side panel, a locking panel joined to said side panel, a front panel attached to said side panel, and a gusset attached between said locking panel and said front panel.

2. The carton blank as defined in claim 1 wherein said gusset includes a central fold line for folding said gusset and bringing said side panel and said locking panel normal to each other.

3. The carton blank as defined in claim 2 being foldable to form a package wherein said side panel and said front panel are disposed generally vertical, said locking panel being disposed horizontal at the bottom edges of said side panel and said front panel, and said gusset being folded inwardly and disposed horizontally upon said locking panel to be engaged by contents of said package.

4. A machine for folding a paperboard blank and forming a package therefrom wherein said blank includes a side panel, an end panel, a locking panel and a gusset attached between said side panel and said end panel, said machine including means for folding said side panel and said end panel normal to each other, means for folding said locking panel to underlie said side panel and said end panel, and means for folding said gusset inwardly of said package for holding said end panel normal to said side panel.

5. The machine as defined in claim 4 including means for disposing said locking panel in a horizontal position, and means for locating said gusset in a horizontal position overlying said locking panel for underlying containers when located within said package.
